(19) United States
(12) Patent Application Publication
(10) Pub. No.: US 2024/0328722 A1
(43) Pub. Date: Oct. 3, 2024

(54) THERMAL ENERGY STORAGE DEVICE AND SYSTEM

(71) Applicant: Mitsubishi Electric Corporation, Tokyo (JP)

(72) Inventors: Christopher OLKIS, Livingston (GB); Georgeanna KAWALEY, Livingston (GB)

(73) Assignee: Mitsubishi Electric Corporation, Tokyo (JP)

(21) Appl. No.: 18/611,693

(22) Filed: Mar. 21, 2024

(30) Foreign Application Priority Data
Mar. 27, 2023 (EP) 23164320.6

(51) Int. Cl. F28D 20/02; F28D 20/00

(52) U.S. Cl. CPC F28D 20/021; F28D 20/0034; F28D 2020/0069

(57) ABSTRACT

A thermal energy storage device comprises a tank and container. The container has an obverse wall, a reverse wall and an internal space. The internal space of the container contains a phase change material, and wherein the obverse wall and/or reverse wall of the container has a substantially planar surface, wherein the substantially planar surface extends from a cross-sectional centre of the container to internal wall of the internal space of the tank. The container is arranged in the internal space of the tank to define a flow path for a fluid in the internal space of the tank, the flow path allows a fluid to flow from opening of the tank partially over a surface of the obverse wall of the container and then partially over a surface of the reverse wall of the container.

### CROSS-REFERENCE TO RELATED APPLICATION

This application is based upon and claims the benefit of priority from European Patent Application No. EP23164320.6 filed on Mar. 27, 2023, the entire content of which is incorporated herein by reference.

A thermal energy storage device (TES) and a system is provided. The TES comprises a tank having internal space and at least one first opening, and at least one container, wherein the at least one container at least has an obverse wall, a reverse wall and an internal space, wherein the internal space of the at least one container contains a phase change material (PCM), and wherein the obverse wall and/or reverse wall of the at least one container has a substantially planar surface, wherein the substantially planar surface extends from a cross-sectional centre of the at least one container to at least one internal wall of the internal space of the tank, wherein the at least one container is arranged in the internal space of the tank to define a flow path for a fluid in the internal space of the tank, characterized in that the flow path allows a fluid to flow from the at least one opening of the tank at least partially over a surface of the obverse wall of the at least one container and then at least partially over a surface of the reverse wall of the at least one container.

Current domestic hot water cylinders store all thermal energy as sensible heat. In addition, they are designed to make use of the density difference between cold and hot water, which creates a stratification zone within the tank. During domestic hot water discharges, a minimum of mixing occurs within the tank. Hence, the bottom part of the cylinder remains at cold mains inlet temperature (e.g. 10° C.) and changes within the narrow stratification zone to the discharge temperature (e.g. 50° C.). Thus, a 200 L cylinder can discharge 200 L of domestic hot water.

Phase change materials have been proposed as an alternative thermal energy storage means, where the energy is largely stored as heat of fusion within a small temperature range. Two types of phase change material thermal energy storage have been proposed. In a first type, the phase change material (PCM) is encapsulated and in the second type, the PCM is not encapsulated. In encapsulated PCM, the PCM is contained by a thin layer of encapsulation material (e.g. plastic or metal). A large number of PCM capsules are then filled into an existing cylinder for domestic hot water (DHW) to enhance its thermal energy storage capacity. The PCM are often intended as retrofits, where they are inserted one by one through a port in the empty DHW cylinder. After filling the cylinder with water, water takes up the voids between the capsules. In non-encapsulated PCM, an outer vessel is filled with PCM and a heat exchanger is submerged into it to extract heat. This design requires a very sophisticated, costly heat exchanger design to extract heat from the bulk of the non-encapsulated PCM.

U.S. Pat. No. 3,960,207 A discloses a thermal energy storage device comprising a tank containing a plurality of hollow, disc-like containers, which are each filled with a thermal energy storage material and placed in a stacked array. Each of the disc-like containers has a hole in the center. A fluid such as air is directed radially inward into the container and is exhausted through the central holes of the disc-like containers which together form a conduit. The flow path of fluid extracts heat from the discs equivalent in a parallel (i.e. non-sequential) manner which leads to constant air outlet temperature for a certain period of time during discharge, but to a sharp drop in temperature after said period of time. Moreover, the thermal energy storage device does not allow for stratification by using different PCM melting temperatures and does not allow simultaneous charging and discharging.

In view of the prior art, it was the object of the present invention to provide a thermal energy storage device and a system which does not have at least one of the disadvantages of the prior art. Preferably, the thermal energy storage device should allow high heat transfer rates at high safety and low costs and/or a steady temperature decrease during discharge at low costs. More preferably, the thermal energy storage device should further have a high heat capacity, allow stratification by using different PCM melting temperatures and/or a simultaneous charging and discharging.

The object is solved by the thermal energy storage device having the features of claim 1 and the system having the features of claim 11. The dependent claims show advantageous embodiments thereof.

According to the invention, a thermal energy storage device (TES) is provided, comprising
a) a tank having internal space and at least one first opening (e.g. an inlet);
b) at least one container, wherein the at least one container at least has an obverse wall, a reverse wall and an internal space, wherein the internal space of the at least one container contains a phase change material (PCM), and wherein the obverse wall and/or reverse wall of the at least one container has a substantially planar surface, wherein the substantially planar surface extends from a cross-sectional centre of the at least one container to at least one internal wall of the internal space of the tank;
   wherein the at least one container is arranged in the internal space of the tank to define a flow path for a fluid in the internal space of the tank;
   characterized in that the flow path allows a fluid to flow from the at least one first opening of the tank at least partially over a surface of the obverse wall of the at least one container and then at least partially over a surface of the reverse wall of the at least one container.

The term “substantially planar” can include being flat to being contoured, having one or more interruptions (such as a texture), having a hole and having a recess.

Since the arrangement of the at least one container in the tank creates a flow path in the tank which allows a fluid to flow from the at least one opening of the tank at least partially over a surface of the obverse wall of the at least one container and then at least partially over a surface of the reverse wall of the at least one container, the TES allows high heat transfer rates because the contact to the container surface is maximized and a directional flow along the container surface is ensured. Since the container is relatively large (extension from a cross-sectional centre of the at least one container to at least one internal wall of the internal space of the tank), this advantage is achieved at higher safety and lower costs compared to a plurality of smaller containers of an equal volume. In fact, with a plurality of containers, manufacturing costs of the TES and the risk of a container failure and a leakage of PCM into the tank would be significantly higher. Furthermore, since the at least one container defines a specific flow path within the tank, a steady temperature decrease during discharge is achieved at low costs, i.e. sharp decreases in temperature of outflowing water are prevented.

The thermal energy storage device (TES) can comprise at least two, preferably at least 20, more preferably at least 30, even more preferably at least 40, optionally at least 50, containers. The advantage of having more containers is that the energy capacity of the TES can be increased while keeping a total surface for contact of fluid with the surface of the containers high, i.e. while maintaining a high high heat transfer rate. However, the total amount of containers in the tank should not be too high to prevent a rising risk of container failure. Preferably, the maximum amount of containers is 100, more preferably 50.

Each of the containers can have at least an obverse wall, a reverse wall and an internal space, wherein the internal space of each of the containers contains a phase change material. The containers are arranged in the internal space of the tank above each other in a stack to define a flow path for a fluid in the internal space of the tank. The flow path allows a fluid to flow from the at least one opening of the tank at least partially over a surface of the obverse wall of the at least one (first) container, then at least partially over a surface of the reverse wall of the at least one (first) container, then, one further container in the stack after the other, at least partially over a surface of the obverse wall and then at least partially over a surface of the reverse wall of each further container in the stack. This configuration of the TES can create a kind of meandering fluid flow path from the at least one first opening of the tank (inlet) to at least one further opening of the tank (outlet), wherein fluid flowing along the flow path contacts surfaces of each container in a sequential (i.e. non-parallel) manner. Thus, a fluid (e.g. water) flowing along the flow path is gradually heated as it flows along the surfaces of the containers.

In a preferred embodiment, the TES comprises at least one spacer, preferably at least two spacers, more preferably at least four spacers, even more preferably at least six spacers, especially at least eight spacers, between each neighbouring pairs of containers to provide at least one first part of the flow path for a fluid between each neighbouring pairs of containers. The first part of the flow path is a part of the flow path which is located between two neighbouring pairs of containers and which allows a contact of the fluid with surfaces of two neighbouring containers.

The at least one spacer (preferably all spacers) provide(s) an at least regionally nonlinear, preferably at least regionally circular, at least one first part of the flow path. This has the advantage that the flow path is prolonged compared to a (strictly) linear flow path, which gives the fluid more time for exchanging heat with the surfaces of two neighbouring containers. In short, the heat transfer rate is increased compared to a (strictly) linear flow path.

The at least one spacer (optionally all spacers) can be realized as a baffle, preferably as a spiral. The stack of containers containing a PCM in combination with at least one baffle determines the flow path of the water inside the tank. Thus, the PCM stratified configuration is different from the stratification of known DHW cylinder units in which the difference in densities of cold and hot water causes the formation of two layers, where the cold-water layer is at the bottom and the hot water layer is on top of it and in which the two layers are separated by a narrow stratification zone in which the temperature changes from cold to hot within a very narrow space.

Furthermore, the at least one spacer (optionally all spacers) can comprise perforated sections. The perforated sections have the advantage that the flow of fluid along the flow path is improved and a risk of a formation of no-flow zones can be avoided.

Moreover, the at least one spacer (optionally all spacers) can be connected to the at least one internal wall of the internal space of the tank. This has the advantage that an assembly of the TES is facilitated and a possibility of an incorrect assembly is ruled out.

If the TES comprises at least two containers, a first of the at least two containers can comprise at least one hole or at least one recess, and a second of the at least two containers comprises at least one hole or at least one recess, wherein the at least one hole or recess of the first of the at least two containers and the at least one hole or recess of the second of the at least two containers each provide at least one second part of the flow path for a fluid. The second part of the flow path is a part of the flow path which goes through each container (without contacting the internal space of each container) and which allows a contact of the fluid with surfaces of each container (i.e. the walls of each container lining the hole and/or recess of each container).

The first and second of the at least two containers are preferably neighbouring containers in the internal space of the tank. Preferably, the first of the at least two containers is located closer to the at least one first opening of the tank than the second of the at least two containers.

Moreover, it is preferred that the at least one second part of the flow path for a fluid is essentially perpendicular to the at least one first part of the flow path for a fluid.

Furthermore, the at least one hole of the first of the at least two containers can be an eccentric hole and/or the at least one hole of the second of the at least two containers can be an eccentric hole. Preferably, the at least one hole or recess of the first of the at least two containers and the at least one hole or recess of the second of the at least two containers are offset to each other in a direction perpendicular to the elongation of each of the at least one hole or recess through each of the at least two containers (i.e. in a direction perpendicular to a stacking direction of the at least two containers), preferably offset by at least half a length of each of the at least two containers in said direction. This extends the fluid path (specifically: the first part of the fluid path) and increases the heat transfer rate.

The at least one hole of the first of the at least two containers can be located at a cross-sectional centre of the first of the at least two containers and the at least one hole or recess of the second of the at least two containers can be located at an edge region of the second of the at least two containers. This extends the fluid path (specifically: the first part of the fluid path) and increases the heat transfer rate. Preferably, the second of the at least two containers comprises at least two, preferably at least four, more preferably at least six, even more preferably at least eight, holes or recesses located at an edge region of the second of the at least two containers, wherein each pair of the at least two holes or recesses is preferably located at opposing ends of the second of the at least two containers. This can increase the surface of the at least two containers over which the fluid is forced to flow along the fluid path of the tank, which can increase the heat transfer rate.

Moreover, the at least one hole of the second of the at least two containers can be located at a cross-sectional centre of the first of the at least two containers and the at least one hole or recess of the first of the at least two containers can be located at an edge region of the first of the at least two containers. This extends the fluid path (specifically: the first part of the fluid path) and increases the heat transfer rate. Preferably, the first of the at least two containers comprises at least two, preferably at least four, more preferably at least six, even more preferably at least eight, holes or recesses located at an edge region of the second of the at least two containers, wherein each pair of the at least two recesses or holes is preferably located at opposing ends of the first of the at least two containers. This can increase the surface of the at least two containers over which the fluid is forced to flow along the fluid path of the tank, which can increase the heat transfer rate.

Furthermore, the at least one recess of the first of the at least two containers can be located at an edge region of the first of the at least two containers and the at least one recess of the second of the at least two containers can be located at an edge region of the second of the at least two containers, wherein the at least one recess of the first of the at least two containers and the at least one recess of the second of the at least two containers are located at opposing ends of the internal space of the tank. This extends the fluid path (specifically: the first part of the fluid path) and increases the heat transfer rate.

If the TES comprises at least two containers, the at least two, preferably at least 20, more preferably at least 30, even more preferably at least 40, optionally at least 50, containers can be arranged in at least two zones, preferably at least three zones, more preferably at least four zones, in the internal space of the tank. This allows to equip the containers with different phase change materials (PCM) in each zone of the tank. Thus, preferably, the containers comprise a PCM which has a melting point which is identical in each zone and different between the zones. More preferably, the containers comprise a PCM which zonally increases in melting temperature or zonally decreases in melting temperature in an axial direction of the tank. For example, the melting temperature of the PCM in each zone can increase from a bottom of the tank to a top of the tank. This arrangement leads to a PCM-stratified configuration and can achieve a higher efficiency during charging, e.g. by a heat pump which is connected to the TES. It also allows simultaneous charging and discharging and/or heat pump assisted discharging. The arrangement in different zones further enables separate charging of the different zones, which can be beneficial for heat pump efficiency.

The at least one container, optionally all containers, of the tank can have a height in the range of 5 to 50 mm, wherein the height refers to a maximum dimension of the container from its obverse wall to its reverse wall.

Moreover, the at least one container, optionally all containers, of the tank can have a length and width in the range of 80% to 100% of a length and width of a cross-section of the internal space of the tank. Preferably, the at least one container, optionally all containers, of the tank have a length which is 100% the length and width of a cross-section of the internal space of the tank, i.e. it is preferable that the at least one container, optionally all containers, contact the wall of the tank which defines the internal space of the tank. This implies that there is no gap between the at least one container (preferably all containers) and the wall of the tank which defines the internal space of the tank. The advantage is that the heat capacity of the tank is maximised and a fluid flow along said wall of the tank, which could lower the heat transfer rate, is prevented, i.e. a maximum heat transfer rate can be ensured. Possible heat losses to the tank wall are also prevented.

Furthermore, the at least one container, optionally all containers, of the tank can have an essentially circular cross-section, an essentially elliptical cross-section, an essentially triangular cross-section or an essentially rectangular cross-section, wherein the term “essentially” encompasses cross-sections regionally deviating from the mentioned cross-sections. Ideally, the cross-section of the at least one container, optionally all containers, of the tank matches the cross-section of the internal space of the tank.

Besides, the at least one container, optionally all containers, of the tank can have a substantially planar, preferably planar, obverse wall surface and reverse wall surface, wherein the term “substantially planar” includes a flat shape, a contoured shape, a locally interrupted shape and a shape with a hole. The advantage is that the flow path for fluid within the tank is as long as possible and a more stable stacking of at least two containers can be realized.

Apart from the above, the at least one container, optionally all containers, of the tank can comprise a material selected from the group consisting of metal, plastic and combinations thereof, wherein preferably, the obverse wall and/or the reverse wall, optionally also at least one side wall of the container, comprise or consist of a material selected from the group consisting of metal, plastic and combinations thereof. If the material is plastic, it is preferred that the plastic has a low wall thickness and a high heat conductivity.

The at least one container, optionally all containers of the tank, can occupy a volume the range of 60 to 95%, preferably in the range of 80 to 90%, of the total volume of the internal space of the tank. Said ranges depict an optimum range between maximum heat capacity on the one hand (caused by the occupied volume) and a maximum heat transfer rate on the other hand (caused by the volume of the fluid path, i.e. the unoccupied volume).

The tank can comprise at least one second opening (e.g. an outlet), preferably in a location opposite to the at least one first opening. In a further preferred embodiment, the at least one opening is an Inlet for mains water and the tank comprises at least one second opening which is an outlet for hot water. The at least one first opening can be located at the bottom of the tank and the at least one second opening can be located at the top of the tank.

Furthermore, the tank can comprise at least one third opening, preferably located in at least one side wall of the tank, more preferably in a region of the at least one side wall of the tank closer to the at least one first opening of the tank than at least one second opening of the tank. The third opening can establish a fluid connection to a heating circuit (comprising e.g. a heat pump) for charging the TES (with heat energy).

Moreover, the tank can comprise at least one fourth opening, preferably located in at least one side wall of the tank, more preferably in a region of the at least one side wall of the tank further away from the at least one first opening of the tank than at least one second opening of the tank. The third opening can establish a fluid connection to a heating circuit (comprising e.g. a heat pump) for charging the TES (with heat energy).

In addition, the tank can comprise at least one fifth opening, preferably in at least one side wall of the tank, more preferably in a region of the at least one side wall of the tank which has a substantially equal distance to the at least one first opening of the tank and at least one second opening of the tank. The third opening can establish a fluid connection to a heating circuit (comprising e.g. a heat pump) for charging the TES (with heat energy).

The at least one third opening, at least one fourth opening and/or at least one fifth opening can allow charging of the PCM within the tank of the TES.

In a preferred embodiment, the internal space of the tank does not comprise any pipes. In fact, pipe arrangements within the internal space of the tank, which some TES according to the prior art comprise to minimise mixing of water during charging and discharging to achieve a strong stratification zone, are not needed in the TES according to the invention. The advantage is that the TES according to the invention can be provided in an easier and less expensive manner and can have a higher heat capacity because no space in the internal space of the tank is lost to pipe arrangements.

The wall of the tank can be thermally insulated. The advantage is that heat losses to the environment are minimized.

In a preferred embodiment, the thermal energy storage device comprises a state of charge (SOC) monitoring system. The SOC monitoring system can be configured to detect a temperature, pressure, conductivity and/or enthalpy (preferably a temperature) of the internal space of the tank of the thermal energy storage device. For example, the SOC monitoring system can be configured to detect
i) a surface temperature of the at least one container (optionally all containers); and/or
ii) a temperature of a fluid exiting the tank of the thermal energy storage device (e.g. exiting a second opening thereof) or a temperature of a fluid flowing through the flow path of the tank; and/or
iii) a temperature if the phase change material in the at least one container (optionally all containers), e.g. if the container(s) is/are in direct contact with the wall of the tank. To this end, a temperature sensor can be fixed in the internal space of the container(s).

The SOC monitoring system can further be configured to convert a detected parameter (e.g. a detected temperature) to a state of charge. The conversion can be based on a temperature-SOC calibration correlation that was initially determined for the tank design from an enthalpy-SOC analysis.

According to the invention, a system is provided which comprises
a) a thermal energy storage device according to the invention;
b) a mains water connection which is thermally connected to the internal space of the tank of the thermal energy storage device;
c) a heating circuit for charging the thermal energy storage device (with heat energy), wherein the heating circuit is thermally connected to the internal space of the tank of the thermal energy storage device.

In the system, the mains water connection is preferably fluidly connected to the first opening of the tank of the thermal energy storage device and the heating circuit is preferably connected to the internal space of the tank of the thermal energy storage device by a heat exchanger. Alternatively, the mains water connection is preferably connected to the internal space of the tank of the thermal energy storage device by a heat exchanger and the heating circuit is preferably fluidly connected to at least one opening of the tank of the thermal energy storage device, i.e. the tank of the thermal energy storage device is directly connected to the heating circuit (and DHW is extracted with a heat exchanger, e.g. Ecocute tank design). The advantage of both alternatives is that the heating circuit is fluidly separated from the flow path for fluid within the TES so that potable water cannot come into contact with fluid flowing through the heating circuit.

In the system, the phase change material of the at least one container can have a melting temperature in the range of 30 to <100° C. wherein the thermal energy storage device is configured to provide heat to the heating circuit and is preferably located completely underground.

Furthermore, in the system, the phase change material of the at least one container can have a melting temperature in the range of ≥100° C., wherein the thermal energy storage device is configured to provide water in the form of steam.

The system can comprise a further thermal energy storage device according to the invention.

The tank of the further thermal energy storage device can comprise a mains water connection which is thermally connected to the tank of the further thermal energy storage device, wherein the heating circuit is thermally connected to the tank of the further thermal energy storage device. In the system, the mains water connection is preferably fluidly connected to the first opening of the tank of the further thermal energy storage device and the heating circuit is preferably connected to the internal space of the tank of the further thermal energy storage device by a heat exchanger. Alternatively, the mains water connection is preferably connected to the internal space of the tank of the further thermal energy storage device by a heat exchanger and the heating circuit is preferably fluidly connected to at least one opening of the tank of the further thermal energy storage device, i.e. the tank of the further thermal energy storage device is directly connected to the heating circuit (and DHW is extracted with a heat exchanger, e.g. Ecocute tank design).

Moreover, the tank of the further thermal energy storage device can comprise a phase change material in the at least one container which has a melting temperature which is different to the melting temperature of the at least one container of the (first) thermal energy storage device.

Furthermore, the tank of the further thermal energy storage device can comprise a phase change material in the at least one container which has a melting temperature in the range of 30 to <100° C., wherein the further thermal energy storage device is configured to provide heat to the heating circuit and is preferably located completely underground.

Besides, the tank of the at least one further thermal energy storage device can comprise a phase change material in the at least one container which has a melting temperature in the range of ≥100° C., wherein the further thermal energy storage device is configured to provide water in the form of steam.

The system can be configured to operate the thermal energy storage device and the further thermal energy storage device in a semi-continuous operation mode in which one of the thermal energy storage device and further thermal energy storage device is charged and the other one of the thermal energy storage device and further thermal energy storage device is discharged, wherein the system preferably comprises a controller which is configured to control the semi-continuous operation mode.

The heating circuit of the system can comprise a heat source which is selected from the group consisting of heat pump, solar thermal heater, gas boiler, industrial waste heat source and combinations thereof.

With reference to the following figures, the subject according to the invention is intended to be explained in more detail without wishing to restrict said subject to the special embodiments shown here.

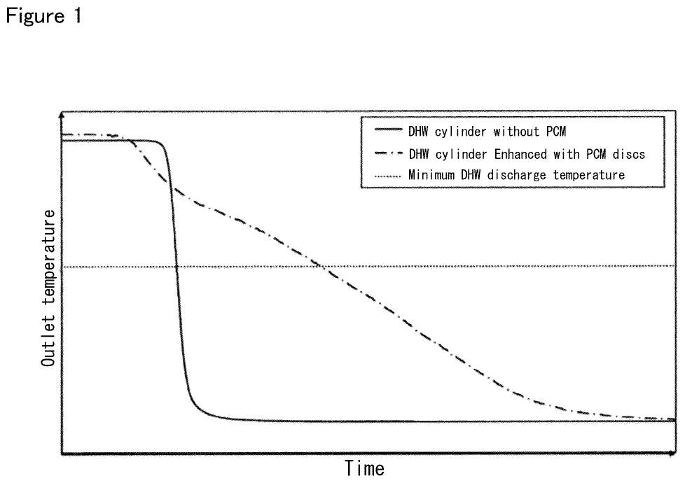

FIG. 1 shows how the PCM discs affect the domestic hot water discharge temperature profile. The discharge profiles shown here depict the same flow rates in both cases. Traditional DHW cylinders feature a thermocline during discharge due to stratification based on density differences between cold mains water at the bottom inlet of the cylinder and hot water at the top of the cylinder. This thermocline leads to a discharge profile in the shape of a sigmoid curve. Thus, traditional cylinder discharge water above the minimum temperature until the thermocline reaches the top of the cylinder causing the temperature to drop below the minimum temperature within a short period of time. Minimum DHW discharge temperatures are defined in standards such as EN 16147. The thermal energy storage device according to the invention comprising PCM discs does not rely on stratification from temperature-based density differences between hot and cold water. Instead, cold mains water is heated gradually as it flows along a fixed flow-path over the PCM discs. As the discs discharge their energy to the water, the outlet temperature is slowly reduced, which leads to a steadier decrease of temperature over time. Thus, water is discharged above the minimum temperature limit for a longer period of time resulting in a larger DHW discharge volume.

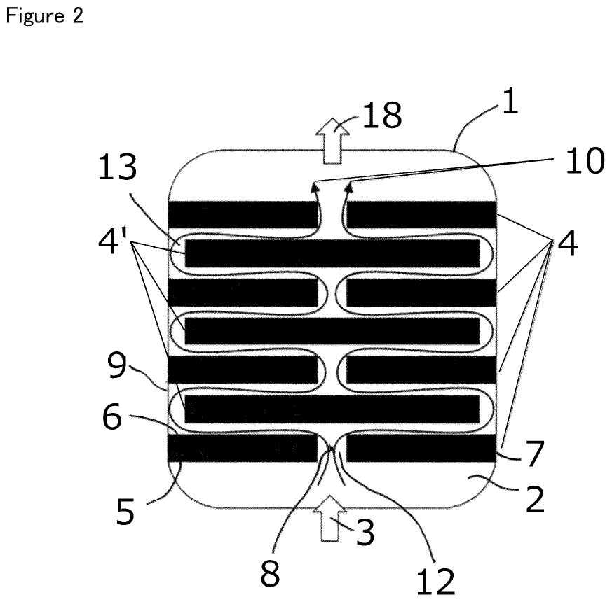

FIG. 2 schematically shows a thermal energy storage device according to the invention. The thermal energy storage device comprises a tank 1 having internal space 2 and at least one first opening 3, and, in this embodiment, 7 containers 4, 4′, wherein each container 4, 4′ at least has an obverse wall 5, a reverse wall 6 and an internal space 7, wherein the internal space 7 of each container 4 contains a phase change material, and wherein the obverse wall 5 and reverse wall 6 of the at least one container has a substantially planar surface, wherein the substantially planar surface extends from a cross-sectional centre 8 of each container 4, 4′ to at least one internal wall 7 of the internal space 2 of the tank 1. Each container 4, 4′ is arranged in the internal space 2 of the tank 1 to define a flow path 10 for a fluid in the internal space 7 of the tank 1. The flow path 10 allows a fluid to flow from the at least one first opening 3 of the tank 1 at least partially over a surface of the obverse wall 5 of each container 4, 4′ and then at least partially over a surface of the reverse wall 6 of each container 4, 4′. Here, the containers 4, 4′ discs are separated by baffles (not shown). Cold mains water enters the tank 1 from the bottom of the tank at the first opening 3 and follows a pre-determined flow path over the entire surface area of the containers 4, 4′. The containers 4, 4′ discharge thermal energy to the cold mains water and gradually heat the water until hot water (DHW) leaves the tank from the top at a second opening 18 of the tank 1. In another embodiment, it is possible to reverse the flow of water and heat cold mains water from top to bottom. In this example, a first type of containers 4 has a larger diameter than a second type of containers 4′, but both types of containers 4, 4′ can also have the same diameter.

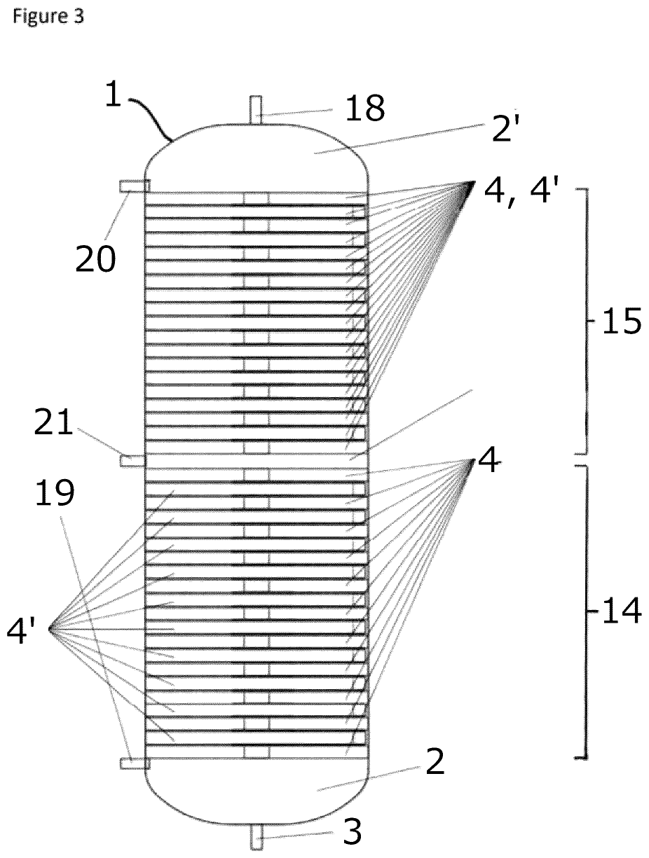

FIG. 3 schematically shows a cross-sectional view of a thermal energy storage device according to the invention containing containers 4, 4′ of two types in alternating arrangement and arranged in a first zone 14 and in a second zone 15. In this embodiment, the tank 1 has at least one third opening 19, at least one fourth opening 20 and at least one fifth opening 21 to connect the tank 1 to a heating circuit (not shown).

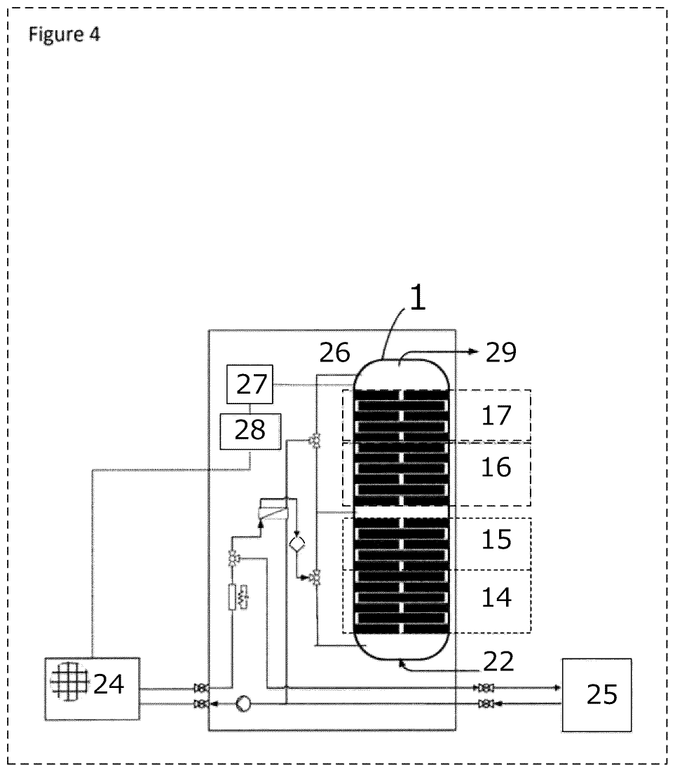

FIG. 4 schematically shows a thermal energy storage device according to the invention being part of a system according to the present invention. Here, the tank 1 is connected to a mains water connection 22 at its bottom and to a DHW outlet at its top. The PCM of the thermal energy storage device are split into a first zone 14, a second zone 15, a third zone 16 and a fourth zone 17, wherein the zones 14, 15, 16, 17 have containers containing PCM with melting temperatures that are different between the zones 14, 15, 16, 17, which are split into two charging sections. The first zone is comprised of zones 14 and 15, while the second zone is comprised of zones 16 and 17. The two charging sections can be charged separately from the heat pump 24 which allows charging of the first section at higher heat pump efficiency, while the section is still available to provide domestic hot water. Furthermore, the system is comprised of a heating circuit 25 directly connected to the heat pump 24. The system further comprises a state of charger analyser 27 and a controller 28.

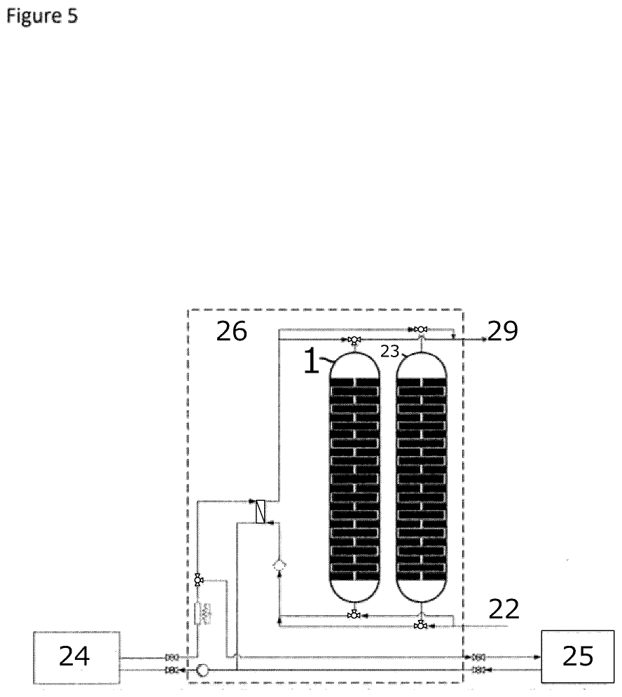

FIG. 5 schematically shows a system according to the present invention. Here, the system comprises a first tank 1 of a thermal energy storage device according to the invention and a second tank 23 of a further thermal energy storage device according to the invention. The two tanks 1, 23 can be charged and discharged separately or simultaneously.

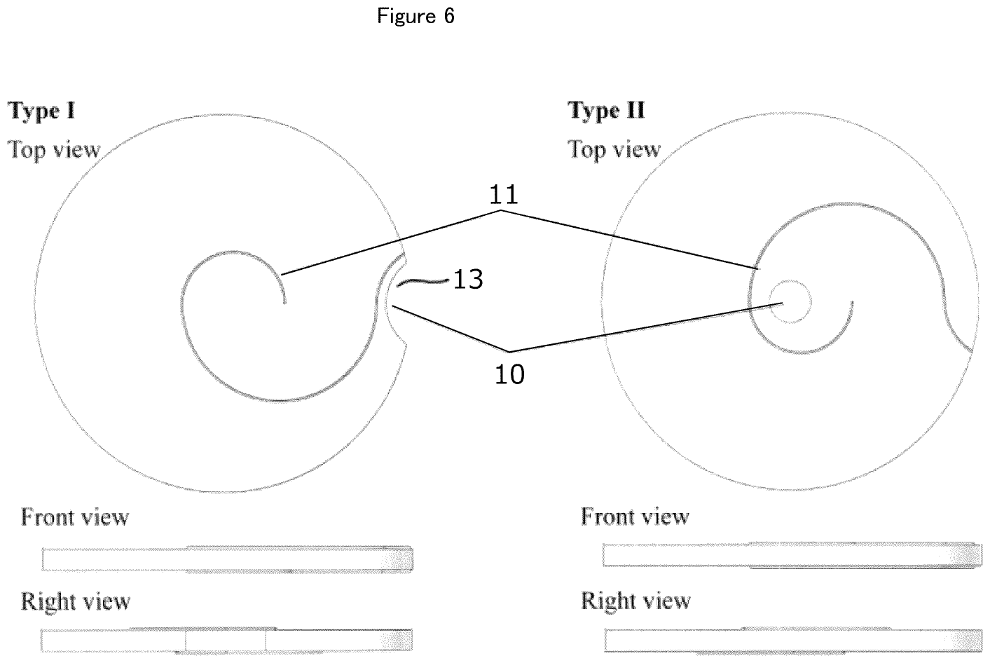

FIG. 6 schematically shows a top view, front view and right view of containers comprising PCM material, in this case PCM discs. The PCM discs of type I and II can be used alternatingly in a stack and be integrated in a tank having a circular cross-section. Spiral spacers 11 in between the PCM discs separate the containers from each other and determine a first part of the flow path 10 of the water in the tank. The spirals force the water to flow around each entire PCM disc and use the entire available heat transfer area. Water can flow from the recess 13 of one container to the hole 12 of the neighboring container. Sections of the spiral spacers 11 can be perforated to avoid no-flow zones and improve heat transfer.

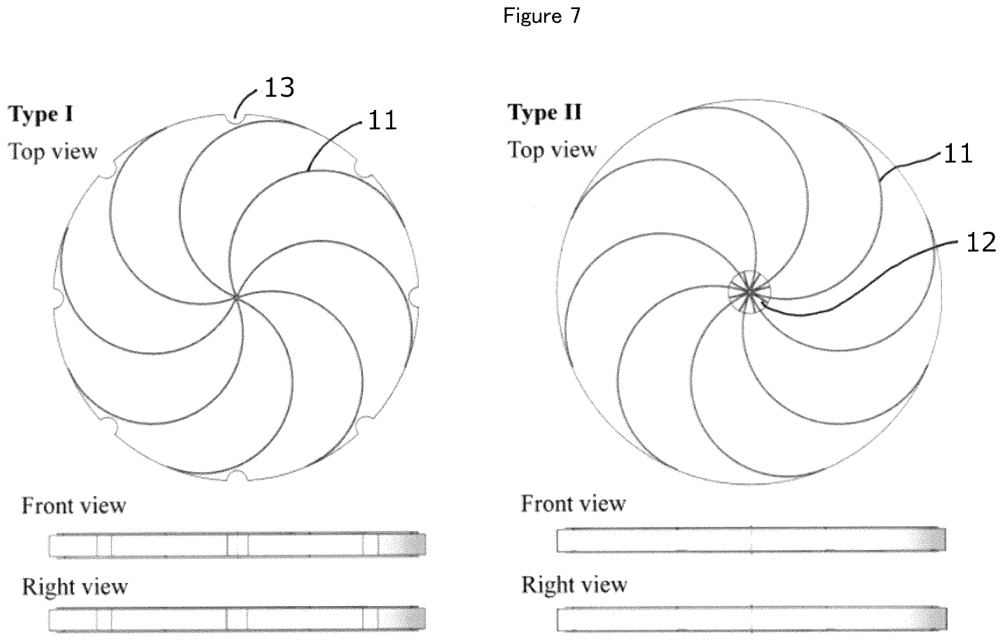

FIG. 7 schematically shows a top view, front view and right view of further containers comprising PCM material, in this case PCM discs. The PCM discs of type I and II can be used alternatingly in a stack and be integrated in a tank having a circular cross-section. Spiral spacers 11 in between the PCM discs separate the containers from each other and determine a first part of the flow path 10 of the water in the tank. The spirals force the water to flow around each entire PCM disc and use the entire available heat transfer area. Water can flow from the recesses 13 of one container to the hole 12 of the neighboring container. Sections of the spiral spacers 11 can be perforated to avoid no-flow zones and improve heat transfer.

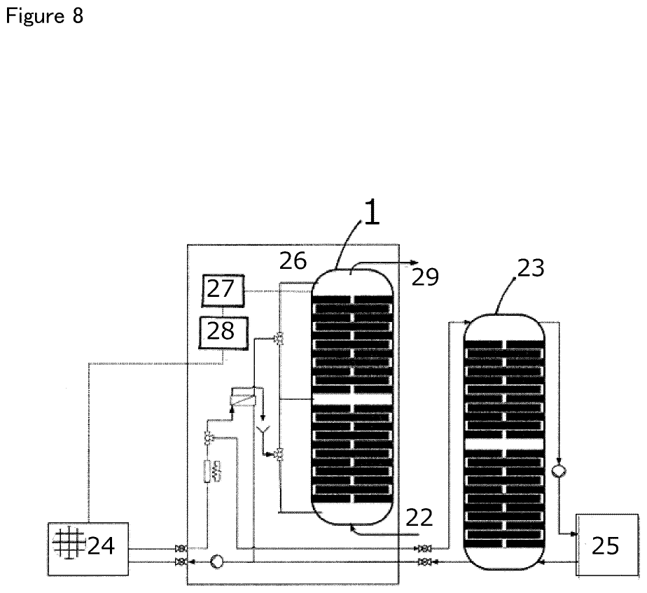

FIG. 8 schematically shows a system according to the present invention. Here, the system comprises a first tank 1 of a thermal energy storage device according to the invention and a second tank 23 of a further thermal energy storage device according to the invention. In this case, the second tank 23 acts as a buffer tank for space heating. The PCM melting temperature can be selected at a suitable melting temperature for space heating. If different types of emitters are installed, the PCM can be split into different PCM zones as shown in FIG. 4, where each zone supplies the corresponding heat emitter type.

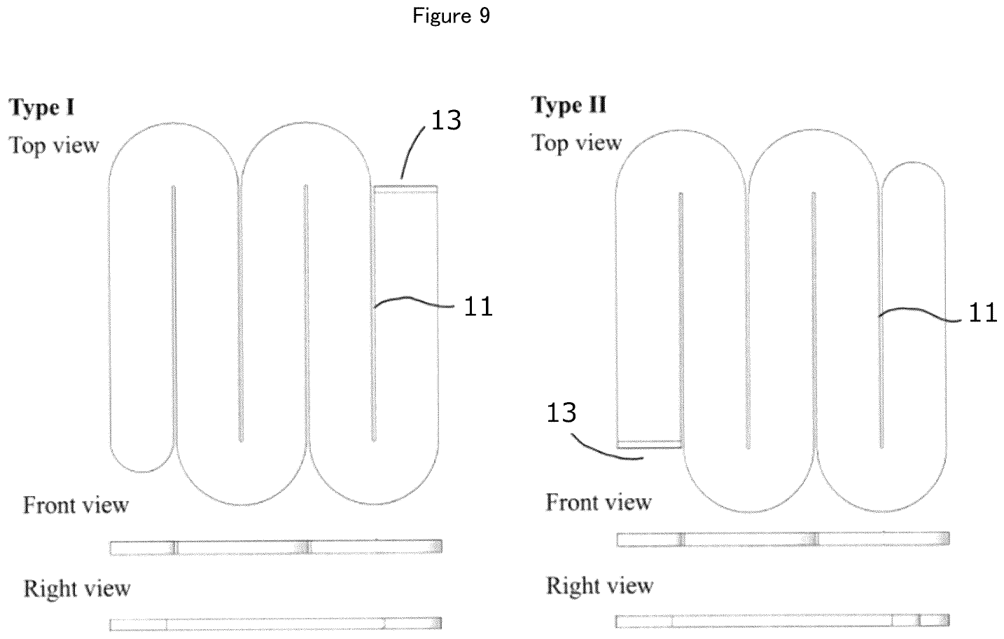

FIG. 9 schematically shows a top view, front view and right view of further containers comprising PCM material, in this case serpentine PCM discs. The serpentine PCM discs of type I and II can be used alternatingly in a stack and be integrated in a tank having a rectangular cross-section. The spacers 11 in between the PCM discs separate the containers from each other and determine a first part of the flow path 10 of the water in the tank. The spacers 11 force the water to flow around each entire PCM disc and use the entire available heat transfer area. Water can flow from the recess 13 of one container to the recess 13 of the neighboring container.

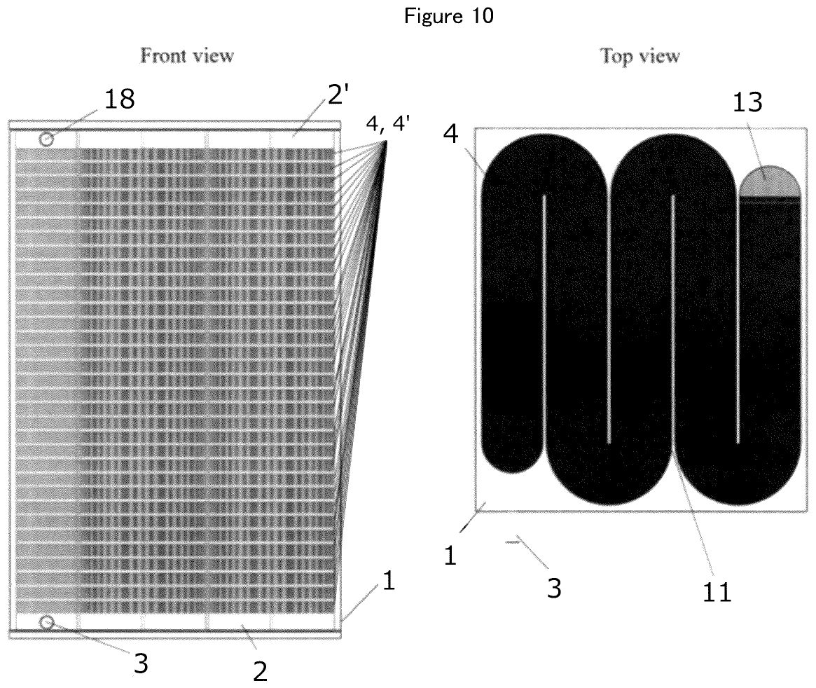

FIG. 10 schematically shows a thermal energy storage device according to the invention. In this example, the serpentine PCM discs shown in FIG. 9 are stacked in a tank with a rectangular chassis to allow for a more compact design. Here, the spacers 11 (baffles) are integrated into the wall of the tank 1. The example shows that the tank 1 has at least one first opening 3 (inlet) and at least one second opening 18 (outlet), but additional charging pipe connections can be advantageous.

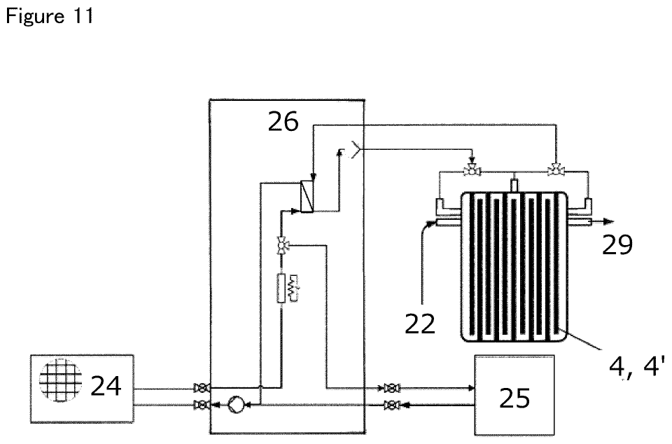

FIG. 11 schematically shows a system according to the present invention. In this example, the system comprises a similar thermal energy storage device (TES) as shown in FIG. 10, but the containers 4, 4′are stacked in a direction parallel to the ground and not in a direction vertical to the ground (like in FIG. 10). Here, the system comprises an air-to-water heat pump as heat source 24, and an indoor unit 26, e.g. a Hydrobox unit. The thermal energy storage device can simultaneously be charged and discharged.

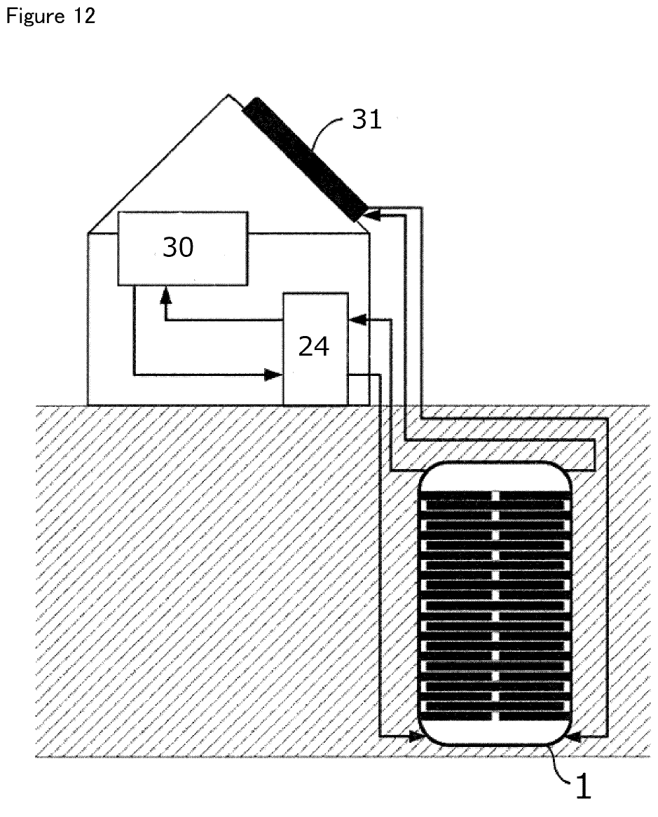

FIG. 12 schematically shows a system according to the present invention. The tank 1 of the thermal energy storage device according to the invention is located underground outside of a building. The underground tank 1 supplies thermal energy to the heat pump 24 inside the building, wherein the system comprises a conventional DHW cylinder located in the building and further supplies energy for space heating and domestic hot water 30. A solar collector 31 is used to charge the thermal energy storage device during solar availability. A large tank 1 increases the energy saving time horizon up to inter-seasonal storage.

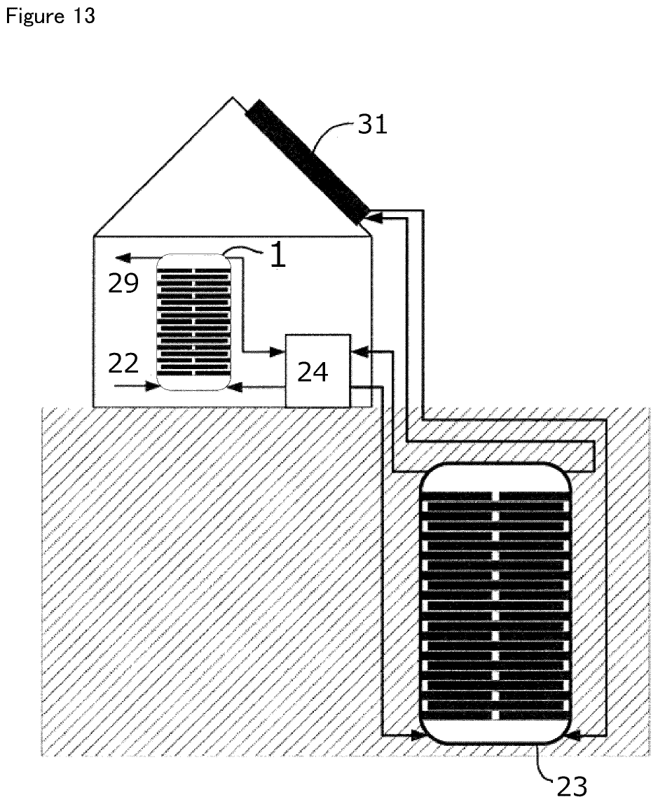

FIG. 13 schematically shows a system according to the present invention. Here, the system comprises a water-to-water heat pump 24 using a large tank 23 of a thermal energy storage device according to the invention on the outside of a building, which supplies thermal energy to the heat pump 24. A smaller tank 1 of a thermal energy storage device according to the invention is located indoors and receives thermal output from the heat pump 24. In another advantageous embodiment, instead of being contained in the large tank 23 of a thermal energy storage device according to the invention, the containers containing PCM are integrated into the pipes of boreholes that are part of a ground source of the heat pump 24. The PCM adds additional heat storage and/or the possibility to store heat on the ground-borehole-side of the ground source heat pump 24 at a lower temperature level.

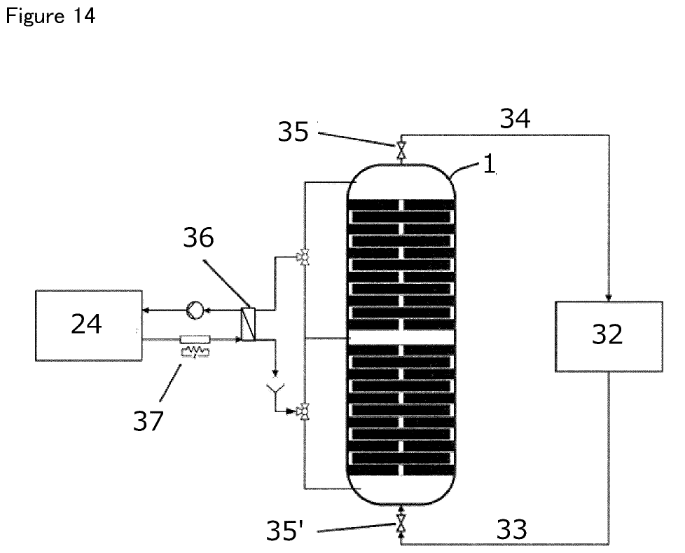

FIG. 14 schematically shows a system according to the present invention. The tank 1 of the thermal energy storage device can be used in larger applications to generate steam for industrial processes. In this example, the TES is charged from a high temperature heat pump 24 as heat source. The TES comprises at least one type of suitable PCM temperature matching the steam requirements of the industrial process.

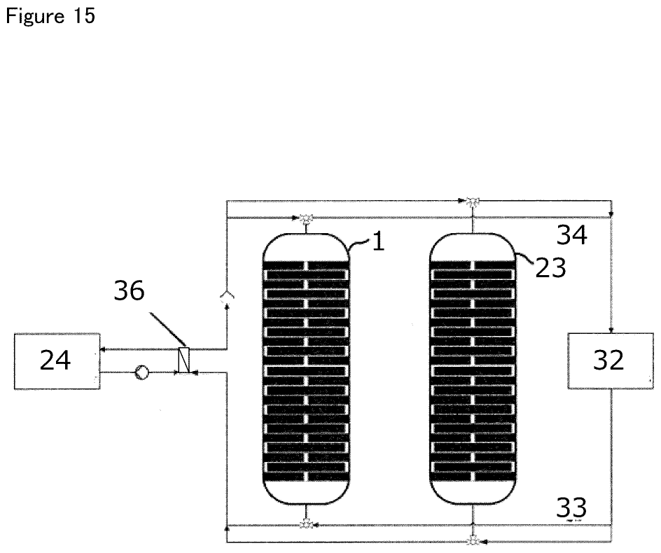

FIG. 15 schematically shows a system according to the present invention. It can be beneficial to have two or more tanks of a thermal energy storage device according to the present invention, wherein the TES are operated in a semi-continuous batch process, where one TES can be charged, while the other TES can be discharged. Different heat sources 24 are also possible, e.g. a heat pump or waste heat from another process. For any heat source, the proposed design allows charging and discharging to occur at different pressures and temperatures.

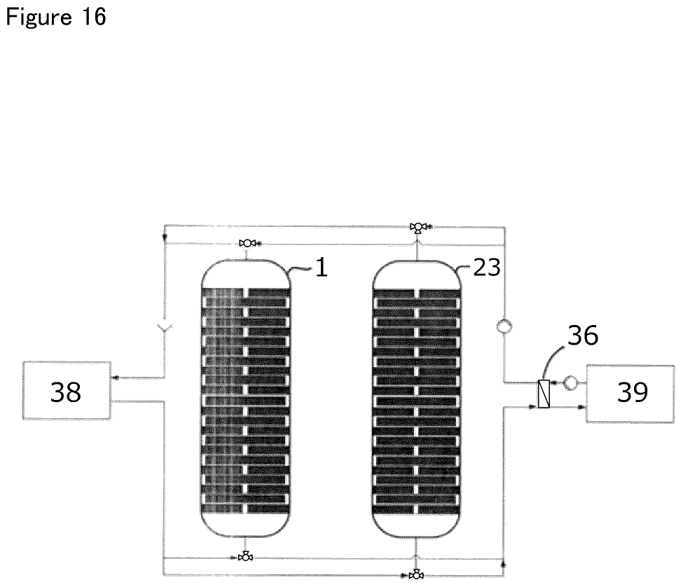

FIG. 16 schematically shows a system according to the present invention. The system is also suitable for a cooling process. In the example shown here, the containers contain low temperature PCM, e.g. melting below ambient temperature. The system can again be operated with two TES in semi-continuous mode. Furthermore, the two TES can be connected to a chiller 38 and separated from the cooling application 39 with a heat exchanger 36. This enables different pressures and working fluids on both sides of the heat exchanger 36.

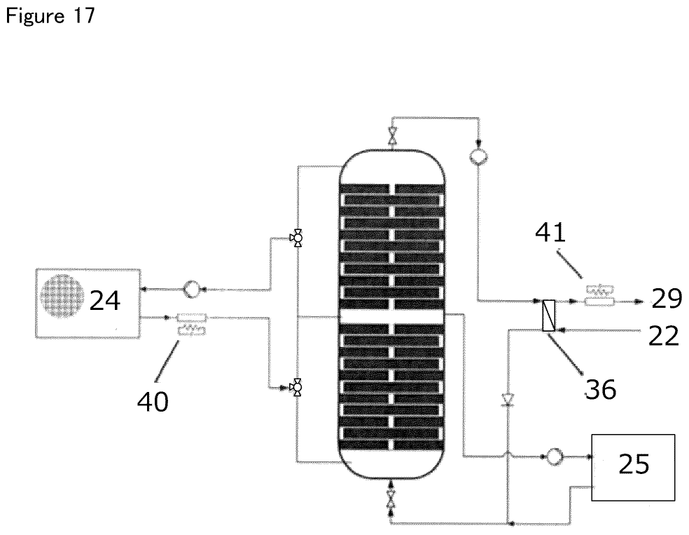

FIG. 17 schematically shows a system according to the present invention. Here, the system comprises a tank 1 of a thermal energy storage device that is directly integrated into the heat pump 24 and heat emitter circuit 25. To provide DHW, hot fluid is extracted from the top of the tank 1 and used to preheat cold mains water from the cold mains water inlet 22 in an external heat exchanger 36, e.g. a plate heat exchanger. This arrangement would prevent any leaking phase change material to contaminate domestic hot water. Furthermore it is depicted in FIG. 17 that the lower section of the containers (PCM discs) can be used as heat storage, preferably using PCM of lower melting temperatures <45° C. FIG. 17 also shows two beneficial locations of a first electrical booster heater 40 and a second electrical booster heater 41. Location 1, where the first electrical booster heater 40 is located, booster heat can be used to top-up heat from the heat pump 24, whereas the second electrical booster heater 41 in the location 2 can be activated when the DHW outlet temperature drops below and threshold to further extend the DHW output volume from the tank 1 and/or in peak demand times.

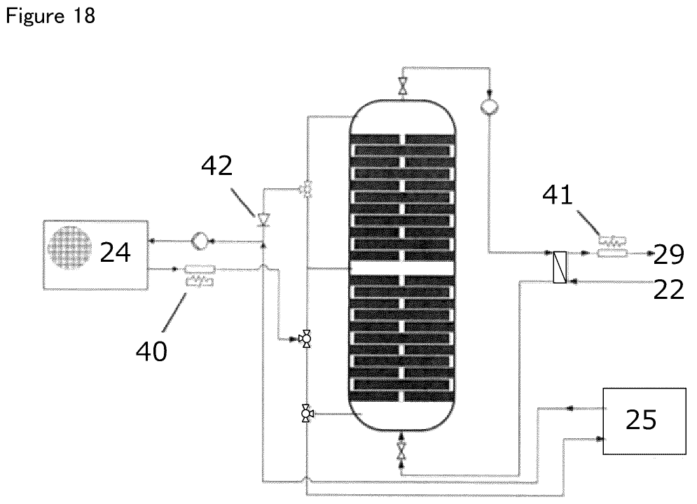

FIG. 18 schematically shows a system according to the present invention, which is a modified version of FIG. 17. Here, the tank 1 is still integrated into the heat emitter circuit 25 and heat pump fluid circuit, but the heat emitter circuit 25 is directly connected to the heat pump 24 (see e.g. direction of arrows and non-return valve 42) and the tank 1 is used as sole DHW TES.

### LIST OF ABBREVIATIONS AND REFERENCE SIGNS

TES: thermal energy storage device;
PCM: phase change material;
1: tank of the TES;
2, 2′: internal space of the tank;
3: at least one first opening of the tank (e.g. inlet for hot water);
4: at least one first container (e.g. at least one first disc);
4′: at least one second container (e.g. at least one second disc);
5: obverse wall of at least one container;
6: reverse wall of at least one container;
7: internal space of at least one container;
8: cross-sectional center of at least one container;
9: internal wall of the internal space of the tank;
10: flow path for a fluid in the internal space of the tank;
11: spacer (e.g. spiral or baffle);
12: at least one hole of the at least one container;
13: recess of the at least one container;
14: first zone of containers;
15: second zone of containers;
16: third zone of containers;
17: fourth zone of containers;
18: at least one second opening of the tank (e.g. outlet for hot water);
19: at least one third opening of the tank (e.g. connected to a heating circuit);
20: at least one fourth opening of the tank (e.g. connected to a heating circuit);
21: at least one fifth opening of the tank (e.g. connected to a heating circuit);
22: mains water connection (mains inlet);
23: tank of a further thermal energy storage device;
24: heat source (e.g. heat pump).
25: heat emitter circuit;
26: system (e.g. indoor unit);
27: SOC monitoring system;
28: controller;
29: DHW outlet;
30: space heating and domestic hot water;
31: solar collector/solar PVT
32: steam process;
33: feedwater (inlet);
34: steam (outlet);
35: valve to seal tank during charging;
35′: valve to seal tank during charging;
36: heat exchanger;
37: electrical steam generator;
38: chiller;
39: cooling application;
40: first electrical booster heater;
41: second electrical booster heater;
42: non-return valve.

1. Thermal energy storage device, comprising
a) a tank having internal space and at least one first opening;
b) at least one container, wherein the at least one container at least has an obverse wall, a reverse wall and an internal space, wherein the internal space of the at least one container contains a phase change material, and wherein the obverse wall and/or reverse wall of the at least one container has a substantially planar surface, wherein the substantially planar surface extends from a cross-sectional centre of the at least one container to at least one internal wall of the internal space of the tank;
wherein the at least one container is arranged in the internal space of the tank to define a flow path for a fluid in the internal space of the tank, and
wherein the flow path allows a fluid to flow from the at least one first opening of the tank at least partially over a surface of the obverse wall of the at least one container and then at least partially over a surface of the reverse wall of the at least one container.

2. Thermal energy storage device according to claim 1, wherein the thermal energy storage device comprises at least two, preferably at least 20, more preferably at least 30, even more preferably at least 40, optionally at least 50, containers,
wherein each of the containers at least has an obverse wall, a reverse wall and an internal space, wherein the internal space of each of the containers contains a phase change material,
wherein the containers are arranged in the internal space of the tank above each other in a stack to define a flow path for a fluid in the internal space of the tank,
wherein the flow path allows a fluid to flow from the at least one opening of the tank at least partially over a surface of the obverse wall of the at least one container, then at least partially over a surface of the reverse wall of the at least one container, then, one further container in the stack after the other, at least partially over a surface of the obverse wall and then at least partially over a surface of the reverse wall of each further container in the stack.

3. Thermal energy storage device according to claim 2, characterized in that the thermal energy storage device comprises at least one spacer, preferably at least two spacers, more preferably at least four spacers, even more preferably at least six spacers, especially at least eight spacers, between each neighbouring pairs of containers to provide at least one first part of the flow path for a fluid between each neighbouring pairs of containers.

4. Thermal energy storage device according to claim 3, characterized in that the at least one spacer provides an at least regionally nonlinear, preferably at least regionally circular, at least one first part of the flow path, wherein the at least one spacer more preferably
i) is realized as a baffle, preferably as a spiral; and/or
ii) comprises perforated sections; and/or
iii) is connected to the at least one internal wall of the internal space of the tank.

5. Thermal energy storage device according to claim 2, characterized in that a first of the at least two containers comprises at least one hole or at least one recess and a second of the at least two containers comprises at least one hole or at least one recess, wherein the at least one hole or recess of the first of the at least two containers and the at least one hole or recess of the second of the at least two containers each provide at least one second part of the flow path for a fluid, wherein preferably
i) the first and second of the at least two containers are neighbouring containers in the internal space of the tank, wherein the first of the at least two containers is preferably located closer to the at least one first opening of the tank than the second of the at least two containers; and/or
ii) the at least one second part of the flow path for a fluid is essentially perpendicular to the at least one first part of the flow path for a fluid; and/or
iii) the at least one hole of the first of the at least two containers is an eccentric hole and/or the at least one hole of the second of the at least two containers is an eccentric hole;
iv) the at least one hole or recess of the first of the at least two containers and the at least one hole or recess of the second of the at least two containers are offset to each other in a direction perpendicular to the elongation of each of the at least one hole or recess through each of the at least two containers, preferably offset by at least half a length of each of the at least two containers in said direction.

6. Thermal energy storage device according to claim 5, characterized in that
i) the at least one hole of the first of the at least two containers is located at a cross-sectional centre of the first of the at least two containers and the at least one hole or recess of the second of the at least two containers is located at an edge region of the second of the at least two containers, wherein preferably the second of the at least two containers comprises at least two, preferably at least four, more preferably at least six, even more preferably at least eight, holes or recesses located at an edge region of the second of the at least two containers, wherein each pair of the at least two holes or recesses is preferably located at opposing ends of the second of the at least two containers; and/or
ii) the at least one hole of the second of the at least two containers is located at a cross-sectional centre of the first of the at least two containers and the at least one hole or recess of the first of the at least two containers is located at an edge region of the first of the at least two containers, wherein preferably the first of the at least two containers comprises at least two, preferably at least four, more preferably at least six, even more preferably at least eight, holes or recesses located at an edge region of the second of the at least two containers, wherein each pair of the at least two recesses or holes is preferably located at opposing ends of the first of the at least two containers; and/or
iii) the at least one recess of the first of the at least two containers is located at an edge region of the first of the at least two containers and the at least one recess of the second of the at least two containers is located at an edge region of the second of the at least two containers, wherein the at least one recess of the first of the at least two containers and the at least one recess of the second of the at least two containers are located at opposing ends of the internal space of the tank.

7. Thermal energy storage device according to claim 2, characterized in that the at least two, preferably at least 20, more preferably at least 30, even more preferably at least 40, optionally at least 50, containers are arranged in at least two zones, preferably at least three zones, more preferably at least four zones, in the internal space of the tank, wherein the containers preferably comprise a phase change material which has a melting point which
i) is identical in each zone and different between the zones; and/or
ii) zonally increases or zonally decreases in an axial direction of the tank.

8. Thermal energy storage device according to claim 1, characterized in that the at least one container, optionally all containers, of the tank has/have
i) a height in the range of 5 to 50 mm, wherein the height refers to a maximum dimension of the container from its obverse wall to its reverse wall; and/or
ii) a length and width in the range of 80% to 100% of a length and width of a cross-section of the internal space of the tank; and/or
iii) an essentially circular cross-section, an essentially elliptical cross-section, an essentially triangular cross-section or an essentially rectangular cross-section, wherein the term “essentially” encompasses cross-sections regionally deviating from the mentioned cross-sections; and/or
iv) a substantially planar, preferably planar, obverse wall surface and reverse wall surface, wherein the term “substantially planar” includes a flat shape, a contoured shape, a locally interrupted shape and a shape with a hole; and/or
v) comprises a material selected from the group consisting of metal, plastic and combinations thereof, wherein preferably, the obverse wall and/or the reverse wall, optionally also at least one side wall of the container, comprise or consist of a material selected from the group consisting of metal, plastic and combinations thereof.

9. Thermal energy storage device according to claim 1, characterized in that the at least one container, optionally all containers of the tank, occupy a volume the range of 60 to 95%, preferably in the range of 80 to 90%, of the total volume of the internal space of the tank.

10. Thermal energy storage device according to claim 1, characterized in that the tank comprises
i) at least one second opening, preferably in a location opposite to the at least one first opening; and/or
ii) at least one third opening, preferably located in at least one side wall of the tank, more preferably in a region of the at least one side wall of the tank closer to the at least one first opening of the tank than at least one second opening of the tank; and/or
iii) at least one fourth opening, preferably located in at least one side wall of the tank, more preferably in a region of the at least one side wall of the tank further away from the at least one first opening of the tank than at least one second opening of the tank; and/or
iv) at least one fifth opening, preferably in at least one side wall of the tank, more preferably in a region of the at least one side wall of the tank which has a substantially equal distance to the at least one first opening of the tank and at least one second opening of the tank.

11. System, comprising
a) a thermal energy storage device according to claim 1;
b) a mains water connection which is thermally connected to the internal space of the tank of the thermal energy storage device;
c) a heating circuit for charging the thermal energy storage device, wherein the heating circuit is thermally connected to the internal space of the tank of the thermal energy storage device.

12. System according to claim 11, characterized in that the phase change material of the at least one container has
i) a melting temperature in the range of 30 to <100° C. wherein the thermal energy storage device is configured to provide heat to the heating circuit and is preferably located completely underground; and/or
ii) a melting temperature in the range of ≥100° C., wherein the thermal energy storage device is configured to provide water in the form of steam.

13. System comprising
a) a thermal energy storage device and a further thermal energy storage device each according to claim 1;
b) a mains water connection which is thermally connected to the internal space of the tank of the thermal energy storage device;
c) a heating circuit for charging the thermal energy storage device, wherein the heating circuit is thermally connected to the internal space of the tank of the thermal energy storage device, wherein the tank of the further thermal energy storage device preferably
i) comprises a mains water connection which is thermally connected to the internal space of the tank of the further thermal energy storage device, wherein the heating circuit is thermally connected to the internal space of the tank of the further thermal energy storage device; and/or
ii) comprises a phase change material in the at least one container which has a melting temperature which is different to the melting temperature of the at least one container of the thermal energy storage device; and/or
iii) comprises a phase change material in the at least one container which has a melting temperature in the range of 30 to <100° C., wherein the further thermal energy storage device is configured to provide heat to the heating circuit and is preferably located completely underground; and/or
iv) comprises a phase change material in the at least one container which has a melting temperature in the range of ≥100° C., wherein the further thermal energy storage device is configured to provide water in the form of steam.

14. System according to claim 13, characterized in that the system is configured to operate the thermal energy storage device and the further thermal energy storage device in a semi-continuous operation mode in which one of the thermal energy storage device and further thermal energy storage device is charged and the other one of the thermal energy storage device and further thermal energy storage device is discharged, wherein the system preferably comprises a controller which is configured to control the semi-continuous operation mode.

15. System according to claim 11, characterized in that the heating circuit comprises a heat source which is selected from the group consisting of heat pump, solar thermal heater, gas boiler, industrial waste heat source and combinations thereof.
